(19) United States
(12) Patent Application Publication
(10) Pub. No.: US 2026/0147977 A1
(43) Pub. Date: May 28, 2026

(54) PERSONALIZED CONTEXT GENERATION FOR A MULTIMODAL RETRIEVAL AUGMENTED GENERATION SYSTEM

(71) Applicant: Dell Products L.P., Round Rock, TX (US)

(72) Inventors: Juarez Monteiro dos Santos Júnior, Tramandaí (BR); Leandro Takeshi Hattori, Campo Grande (BR); Sarah Hannah Lucius Lacerda de Góes Telles Carvalho Alves, Rio de Janeiro (BR); Smriti Bajaj, Seattle, WA (US)

(21) Appl. No.: 18/960,452

(22) Filed: Nov. 26, 2024

(51) Int. Cl. G06F 40/166; G06V 30/413; G06V 30/414

(52) U.S. Cl. CPC G06F 40/166; G06V 30/413; G06V 30/414

(57) ABSTRACT

A personalized context generation for a multimodal retrieval augmented generation system is disclosed. Personalized context, which may be included in a model prompt, is generated by initially generating summarized texts corresponding to documents. The summarized text includes text summaries from multiple document modalities. In response to a query, a set of text summaries that are closest to the query are retrieved from the summarized texts. The personalized context is generated from the set of text summaries by identifying highly relevant portions of text from the set of text summaries. The relevant portions are personalized context that are added to the prompt along with the query. Personalized content is returned from the model in response to the contextualized prompt.

### TECHNOLOGICAL FIELD OF THE DISCLOSURE

Embodiments disclosed herein generally relate to multimodal retrieval augmented generation systems and methods. More particularly, at least some embodiments relate to systems, hardware, software, computer-readable media, and methods for generating personalized context with a multimodal retrieval augmented generation system.

### BACKGROUND

Retrieval augmented generation (RAG) is an artificial intelligence/machine learning technique that integrates information retrieval with text generation. RAG is designed to enhance the abilities and capabilities of large language models (LLMs) by anchoring the LLMs in external knowledge sources. Anchoring the LLMs to knowledge sources helps ensure that the LLMs have access to current and reliable data. Thus, RAG systems increase the accuracy and trustworthiness of responses generated by LLMs, while providing computational and financial benefits for LLM based applications.

Conventional RAG systems, however, rely primarily on textual data. Conventional RAG systems overlook or poorly analyze other visual elements such as images, tables, charts, equations, and diagrams. This inability can result in responses that are less than optimum. More specifically, the inability of RAG systems to process visual elements other than text may result in a loss of information or may not provide the best possible output.

Even though there are some systems, such as multimodal RAG (MRAG) systems that purport to build on RAG's foundation by integrating multiple data modalities, these systems currently struggle to generate summarizations of diverse visual and textual elements and often ignore information that is relevant to building contextual prompts.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1 discloses aspects of a multimodal retrieval augmented generation system that includes an offline pipeline and an online pipeline;

FIG. 2 discloses aspects of converting images in a list of images to a list of objects in the offline pipeline;

FIG. 3 discloses aspects of generating a list of summarized texts from the list of objects in the offline pipeline;

FIG. 4 disclose aspects of augmented selection in the online pipeline;

FIGS. 5A-5D disclose aspects of an example of generating personalized context that can be included as context for prompting a large language model; and

FIG. 6 discloses aspects of a computing device, system, and/or entity.

### DETAILED DESCRIPTION OF SOME EXAMPLE EMBODIMENTS

Embodiments disclosed herein generally relate to multimodal retrieval augmented generation (MRAG) systems and methods. More particularly, at least some embodiments relate to systems, hardware, software, computer-readable media, and methods for MRAG systems configured to generate personalized context using multiple expert models (MEM).

In one embodiment, an MRAG system is configured to analyze visual elements within documents or other knowledge sources. Embodiments of the MRAG system retrieve relevant information from each modality (e.g., text, image, chart, table, diagram) in a document, aggregate insights across different data types, and generate coherent and comprehensive results such as textual summaries for each of the modalities. This allows the MRAG system to be applied in various domains, including document summarization, information retrieval, and data-driven decision-making.

Another application of an MRAG system is the use of raw information to contextualize prompts for large language models (LLMs). Contextualizing the prompts helps ensure that relevant data is retrieved and used in generating a response. Embodiments of the invention further account for available token space in a prompt, thereby overcoming issues associated with the desire to increase the amount of information inserted into the contexts of prompts input to LLMs.

In one example, an MEM strategy for an MRAG system generates textual summarizations of documents that include multiple data type, which is distinct from conventional RAG systems that do not extract all available information from documents other than text. By extracting textual summarizations for multiple modalities, embodiments of the invention are configured to enrich an LLM prompt with different multimodal context. The ability to personalize a prompt for an LLM context increases the chances of delivering more desirable responses from the knowledge sources, thereby enhancing the user's experience.

Embodiments of an MRAG system include offline and online stages or phases. The offline stage may include multimodal information extraction (MIE). MIE may include document conversion, layout detection, visual summarization, and storage. Document conversion includes converting each document into images. Layout detection includes, for each document image, identifying and obtaining objects and their classifications. Once the objects in the document images are identified, visual summarization crops the objects (each of the objects is a cropped image in one example) from the document images and inputs the cropped objects into models along with their classifications. The models generate a summary (e.g., a textual summary) for each of the objects, often in a text format. More specifically, the model extracts the summarized meaning from the content of the object input to the model. The summaries are embedded and stored in a vector database or storage. The texts or summaries may be indexed to their respective images.

The online stage or phase includes personalized context generation. Personalized context generation includes information retrieval, augmentation selection, and personalized context generation. In information retrieval, a user's query is represented as a vector (e.g., the query is embedded) and compared with embeddings (vectors) previously stored in the vector database during the offline stage. This allows text or documents that match or most closely match the query to be selected.

Augmentation selection identifies highly related content based on the relationship between the query and the vectors (or documents) retrieved from the storage. The most relatable content is selected during augmentation selection. The selected documents may be sent to an LLM (may be the same as or different from the LLM used to generate a response to the query) to generate concise summaries. The concise summaries may be used as personalized context to enrich a prompt. Personalized context generation may include generating a prompt that combines the query with the personalized context such that the LLM generates a response that is more accurate with respect to the query.

Embodiments of the invention relate to MRAG systems that handle multiple data modalities and that enhance the context of an LLM prompt by personalizing the context for the user and/or to the query. MRAG systems can thereby improve various applications including LLM based applications such as document analysis, chatbot applications, question/answer applications, and the like.

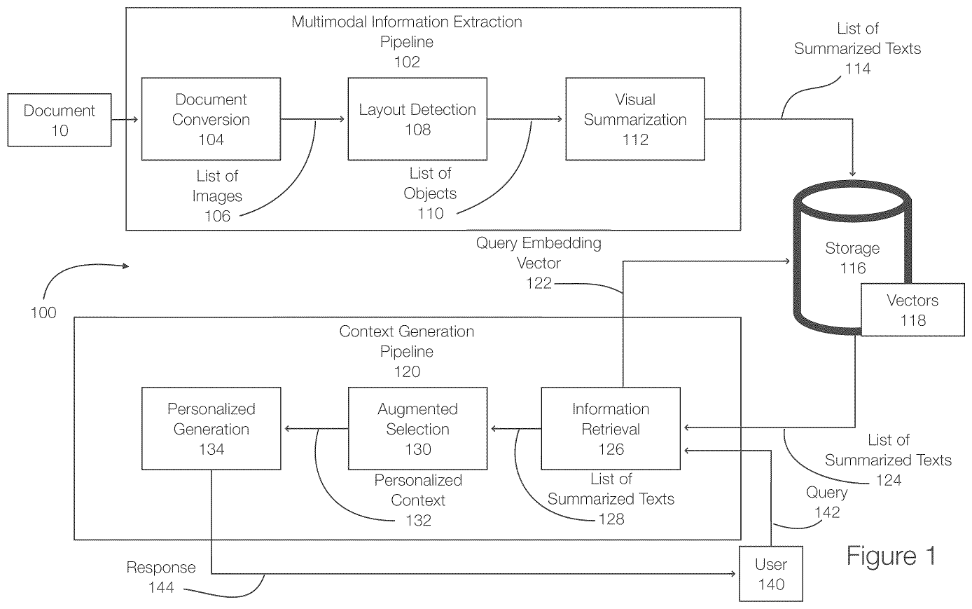

FIG. 1 discloses aspects of a multimodal retrieval augmented generation (MRAG) system that includes an offline and an online pipeline. The MRAG system 100 allows a workflow to be performed using a multimodal information extraction pipeline 102 and a context generation pipeline 120.

In one example, the pipeline 102 may be performed/executed offline and the pipeline 120 may be performed/executed online. The pipeline 102 may be executed as needed, periodically, or the like. The pipeline 120 is typically performed/executed in response to a query 142 from a user 140. Although the pipelines 102 and 120 have some reliance, the pipelines 102 and 120 can be executed asynchronously, synchronously, or the like.

Generally, the pipeline 102 receives a document 10 (e.g., a document, a batch of documents). The document 10 is processed in the pipeline 102 to generate or output a list of summarized texts 114 (e.g., one for each document) that are stored in a storage 116. More specifically, the pipeline 102 performs document conversion 104 to generate a list of images 106, layout detection 108 to generate a list of objects 110 from the list of images 106, and visual summarization 112 to generate the list of summarized texts 114 from the objects in the list of objects. The list of summarized texts 114 may be embedded prior to storage in the storage 116. The vectors 118 thus represent embeddings of the summarized texts 114.

The pipeline 102 is discussed with respect to a single document, but may be performed for multiple documents. For example, multimodal information extraction may commence with the document 10. Document conversion 104 includes, by way of example only, converting the document 10 into a list of images 106. In one example, each page, slide, or other portion of the document 10 is converted into an image. The document 10 may have any format, such as portable document format (PDF), word processing format, presentation (slides) format, scanned image format, or the like. The conversion may be performed by the document conversion 104 using various libraries, such as python libraries. The output of the document conversion 104 is a set or list of images 106 that correspond to the document 10. For example, an image may be generated for each page, each slide, each scanned page/slide, or the like, of the document 10.

The images identified by the list of images 106 are provided to the layout detection 108. In the layout detection 108 phase of the pipeline 102, a list of objects 110 is generated from the list of images 106. The list of objects 110 identifies objects of the document images. Multiple objects may be generated from each of the images included in the list of images 106. In one example, the layout detection 108 operates to detect and classify distinct types of visual elements present in the images identified in the list of images 106.

The layout detection 108 may include various models such as Detectron2, laion/clip-vIt-dATAcOMP.xl-S13b-B90k, omoured/YOLOv10-Document-Layout-Analysis, Narsil/layoutlmv3-finetuned-funsd, or the like. In some examples, the objects detected in the list of images 106 may be normalized, resized, or the like. The models are configured to identify different types of objects in each of the document images. The objects may include text objects, chart objects, image objects, diagram objects, and the like.

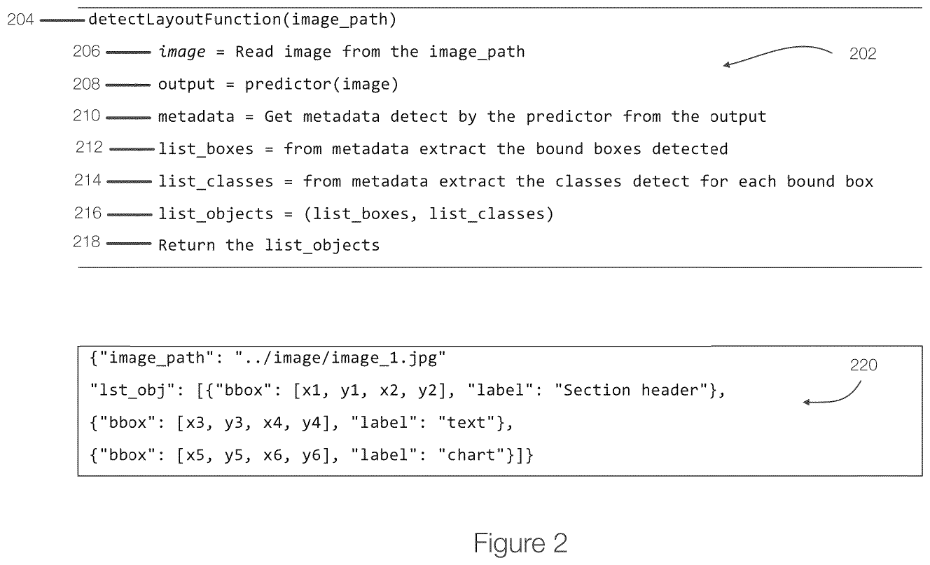

FIG. 2 discloses aspects of converting the images in the list of images to objects. FIG. 2 illustrates a method 202, which is an example of layout detection 108. The method 202 may be a function or other operation configured to transform each of the images in the list of images 106. The method 202 generates a list of objects 220, which is an example of the list of objects 110.

More specifically, the method 202 includes providing 204 a path to the images to the layout detection 108. After reading 206 an image, a predictor generates 208 a prediction or output based on the image. More specifically, the predictor may evaluate the image to identify and separate out the various visual elements. Thus, the predictor may identify regions or boxes that include a particular type of content. The output of the prediction may include a classification (e.g., text, table, image) for each of the identified regions. More generally, the predictor may include models, such as the models previously discussed, that are configured to detect and classify distinct types of visual and/or textual elements in the image. Metadata is obtained 210 for the output of the predictor. In one example, the predictor may also parse the image into objects, which each object corresponds to a labeled content type.

The output of the predictor (or models) includes 212 a list of bound boxes (objects) detected by the predictor and includes 214 a class or labels for each of the bound boxes. This allows a list of objects to be generated 216 and returned by the method 202. In effect, the visual elements of a document image can be identified and typed or classified. Portions of the image that include text are boxed and labeled as text. Portions of the image that include tables are boxed and labeled as tables. Other visual elements are similarly labeled.

The list of objects 220 is an example of the list of objects for an image included in the list of images. The method 202 may be performed for each of the images of each of the documents. When completed, the list of objects 110 includes objects from each of the images in the list of images 106 for the documents being processed.

The list 220 illustrates a portion of the list of objects and more specifically illustrates objects or a list of objects for a specific image. In this example, each bound box in the image “image_1.jpg” is identified by or associated with coordinates and a label. As illustrated, the labels (e.g., section header, text, chart, image, label), which are presented by way of example only, represent the distinct types of visual and/or textual elements that may be present in a document or in an image of the document or portion thereof.

After the list of objects 110 is generated or determined from the document 10, visual summarization 112 is performed to generate a list of summarized texts 114. The list of summarized texts 114 may represent the summarized text for all of the objects of a particular document image, of all objects from all document images of a particular document, or all objects from all document images of all documents being processed in the pipeline 102.

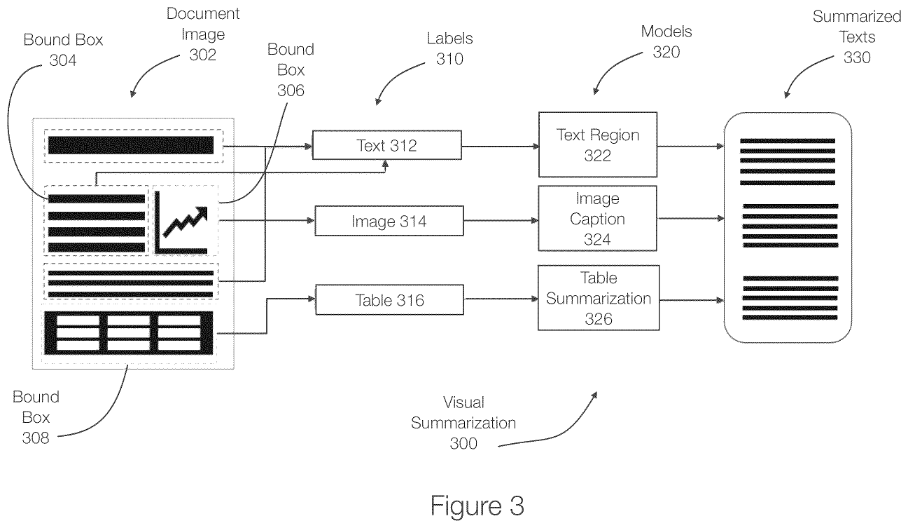

FIG. 3 discloses aspects of generating a list of summarized texts from a list of objects. More specifically, FIG. 3 illustrates visualization summarization 300, which is an example of visual summarization 112, for a specific document image 302. In this example, a document image 302 has been generated and the objects for the document image 302 have been identified during layout detection. In this example, objects are illustrated as they are arranged on the image 302 (but may be extracted and stored separately). The bound boxes 304, 306, and 308 are examples of or correspond to objects identified in the document image 302.

During layout detection 108, the objects are identified and labeled. In this example, the bound box 304 represents text or an object classified as text, the bound box 306 represents an image or an object classified as an image, and the bound box 308 represents a table or an object classified as an table. Thus, the bound box (the object) 304 is labeled as text 312, the bound box (object) 306 is labeled as an image 314, and the bound box (object) 308 is labeled as a table 316.

More specifically, after the layout detection 108 generates a list of objects in the document image 302, the visual summarization 300 receives the list of objects (e.g., bound boxes, classes, and/or labels). The visual summarization 300 extracts and generates textual summaries. Thus, text from the object 304 is summarized. Text from the object 306 is generated and summarized. Text from the object 308 is generated and summarized. The models used to generate the textual summaries may vary and may depend on the object's label. In one example, this is achieved using an expert multimodal approach where a particular model is selected for a particular visual element or a particular object. The models 320 are configured to generate the summarized texts 330.

More specifically, the objects included in the list of objects 110 are cropped from the document image 302 (thus the bound boxes 304, 306, 308 also represent cropped images). More specifically, the objects are still represented as images at this stage in one example. Thus, cropping the objects is achieved by cropping portions of the image 302 corresponding to the area of the image defined by the coordinates. Each of the cropped images may be stored separately along with their label. For example, the bound box (or object) 308 and the label of table 316 may be stored separately from other objects.

More specifically, the individual objects (cropped images) from the document image 302 are input to models configured to extract and summarize information contained therein. These models 320 may be configured to extract specific types of content. For example, a text region model 322 may be configured to extract text using optical character recognition (OCR), Tesseract, Google Vision, or the like from objects classified as containing text. An image caption model 324 may be configured to process images to extract textual content. A table summarization model 326 may be configured to extract and generate textual content from tables. Examples of image caption models 324 and/or table summarization models 326 may include LLAVA, Chart-LLAMA, Chart Assistant, DeepSeeK. The models 320 may include a single robust model, a set of models with or without prompt engineering techniques.

The output of the visual summarization 300 includes a list of summarized texts 330 for each the document image 302. Thus, each of the document images of a document is associated with a summarized texts. The summarized texts 330 may be stored in a storage. More specifically, the summarized texts 330 may be embedded and stored in an embedding vector format as vectors 118 in the storage 116.

In some examples, the same model may be used to generate text summaries for different labels. In one example, the prompt may include the label to bias the output based on the input type.

Returning to FIG. 1, the multimodal information extraction pipeline 102 is configured to generate a list of summarized texts 114 from document 10 input to the pipeline 102. Multiple models are used in during layout detection 108 and/or visual summarization 112 such that the list of summarized texts 114 allows for distinct types of content to be reflected in the list of summarized texts 114.

FIG. 1 also illustrates a context generation pipeline 120. The pipeline 120 is configured generate an improved response 144 to a user's query 142 compared to conventional systems including RAG systems. The pipeline 120 is an online phase or aspect of generating a response to a query.

The pipeline 120 includes various phases or aspects including information retrieval 126, augmented selection 130, and personalized generation 134. Information retrieval 126 may retrieve a list of summarized texts 124 from the storage 116 based on a query 142 received from a user 140. Information retrieval 126 may also optimize the list of summarized texts 124 to include the most relevant summarized texts included in the lists of summarized texts 124 retrieved in response to the query 142 to generate the list of summarized texts 128, which are input to augmented selection 130. In another example, the list of summarized texts 128 may be the same as the list of summarized texts 124.

Because the list of summarized texts 128 may include long sentences, which may consume a large language model's token capacity, augmented selection 130 is configured to select specific summarized texts or portions thereof in view of the token size of the LLM. More specifically, highly relevant sentences (or portions thereof or other texts) are selected from the list of summarized texts 128. The output of augmented selection 130 is an example of personalized context 132.

The personalized generation 134 generates a response 144 to the query 142. In one example, personalized generation 134 aggregates the personalized context 132 with the query 142 to generate a prompt to a large language model. The output of the large language model is generated during personalized generation 134 and returned to the user 140 as the response 144.

More specifically, the user 140 may submit a query 142 to an MRAG system 100. This may be done via a user interface and may occur over a network. A user operating a device (computer, smartphone, tablet) may access a service (the MRAG system 100) and submit a query 142. The service may be a general search service, a chatbox, a question/answer service, or the like that is based on the MRAG 100.

The query 142 is received by the information retrieval 126. The query 142 is converted into a query embedding vector 122, using a pre-trained model (e.g., BERT, RoBERTa), and compared to the vectors 118 stored in the storage 116 to determine similarity. In one example, a cosine similarity measurement is used to score or determine a relationship between the query embedding vector 122 and vectors 118 stored in the storage 116. The most relevant summarized texts 124, corresponding to the closest vectors that are closest to the query 142, are retrieved. In other words, by determining a distance measurement between the vectors 118 and the query embedding vector 122, the most similar vectors in the storage 116 can be identified and retrieved.

Each of the vectors 118 may represent or define a corresponding documents in different ways. Some vectors may represent a piece of text (e.g., a sentence) extracted from the document image while other vectors may represent all text from a document image. For example, each object may be associated with one or more embeddings. This allows the most similar objects to be identified.

In one example, regardless of the representation, the complete summarization texts from a document image is retrieved and added to the list of summarized texts 124 regardless of how the vectors 118 are formed in one example. The number of summarized texts retrieved in response to the query 142 may be based on a threshold number. Once the list of summarized texts 124 are retrieved by the information retrieval 126, augmented selection 130 may be performed on the list of summarized texts 128.

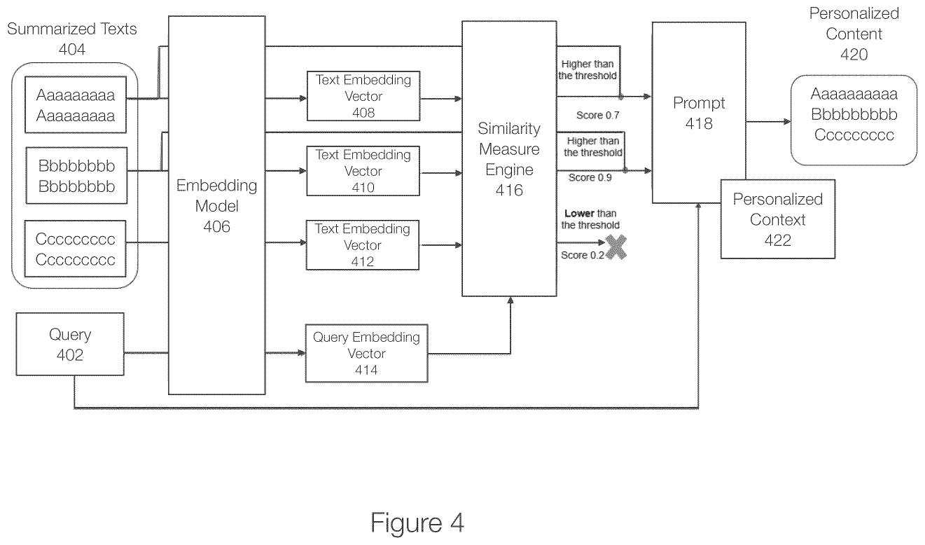

FIG. 4 discloses aspects of augmented selection 130. The list of summarized texts 404 may include long text that includes multiple sentences. This length may consume a significant amount of the token capacity of a large language model. Augmented selection 130 addresses at least this potential issue. In one example, sentences (or portions thereof) from the summarized texts 404 are embedded by an embedding model 406. The user query 402 is also embedded by the embedding model 406. Because the text generated from a particular object may include multiple sentences, each of the sentences are considered and embedded during augmented selection 130. This example does not illustrate all of the sentences from all of the objects.

This results in, by way of example, text embedding vectors 408, 410, and 412, and query embedding vector 414. This ensures that sentences from the summarized texts 404 are embedded in one example. A similarity measure engine 416 compares (e.g., generates a distance measurement) the query embedding vector 414 to each of the text embedding vectors 408, 410, and 412. This may result in a score for each text embedding vector that can be compared to a threshold score.

If the score is less than the threshold, the corresponding text is removed from consideration because the text is not sufficiently similar to the query 142. In this example, the score of the text embedding vector 412 is 0.2 (less than a threshold of 0.5). As such, the text embedding vector 412 is not sufficiently similar to or close to (e.g., in terms of a distance measurement) the query embedding vector 414 and is discarded. In this example, the scores for the text embedding vectors 408 and 410 are above the threshold of 0.5.

The texts, (e.g., sentences or portions thereof) that satisfy the threshold requirement of the similarity measure engine 416 represent an example of personalized context 422 that can be included in a prompt 418. The prompt 418 thus includes or reflects the personalized context 422 and the query 402 (or representations thereof). In effect, the prompt is contextualized with highly relevant content from the summarized texts 404.

The prompt 418, which includes the personalized context 422, may be input to a large language model and the response of the LLM is an example of personalized content 420. The personalized context 422 can influence the personalized content 420 returned by the large language model. More specifically, the personalized context 422 allows texts that are closely related to the query 402 to be included in the prompt 418 while excluding texts that are less relevant to the query 402 and have lower scores.

In one example, the texts identified by the similarity measure engine 416 may be input to a large language model in order to generate concise text summaries, which are an example of the personalized context 422.

In one example, augmented selection is performed for each sentence in the list of summarized texts 128 and may result in a concise list of highly relevant content to the user at least because the texts that do not satisfy the threshold are removed or not included in the personalized context 422. Embodiments of the invention thus infuse the prompt 418 with meaningful context, which empowers the large language model to deliver more precise and more relevant responses, which may improve user engagement.

Personalized generation 134 is performed by providing the enhanced prompt 418 as input to the large language model. More specifically, the personalized context 422 and the user query 402 may be aggregated as the prompt 418. The prompt 418 is input to a large language model and the response 144 (the personalized content 420) of the large language model is returned to the user 140.

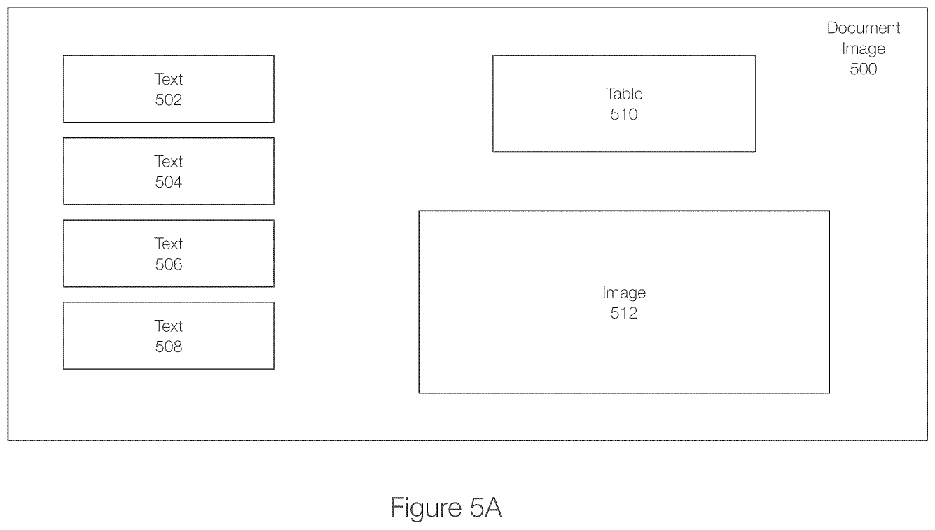

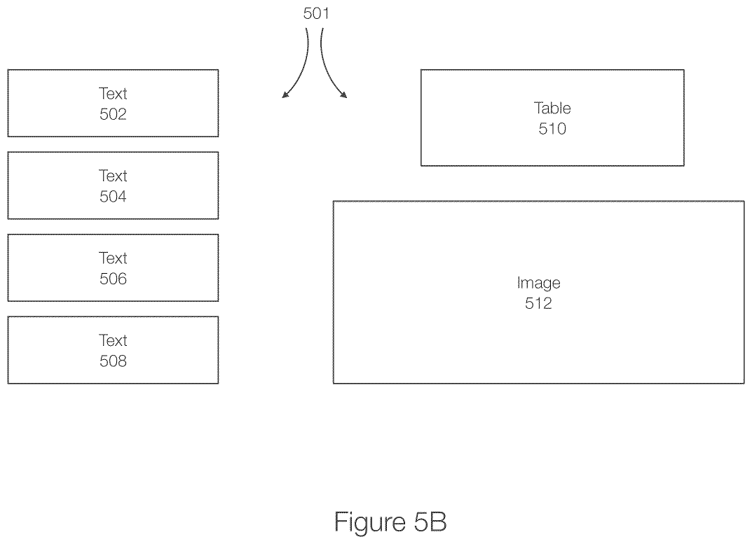

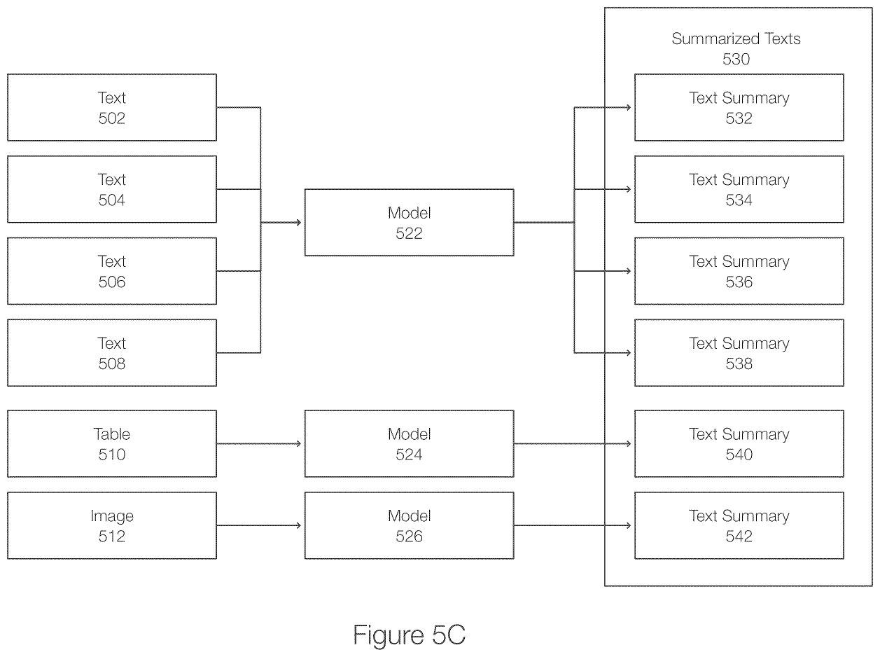

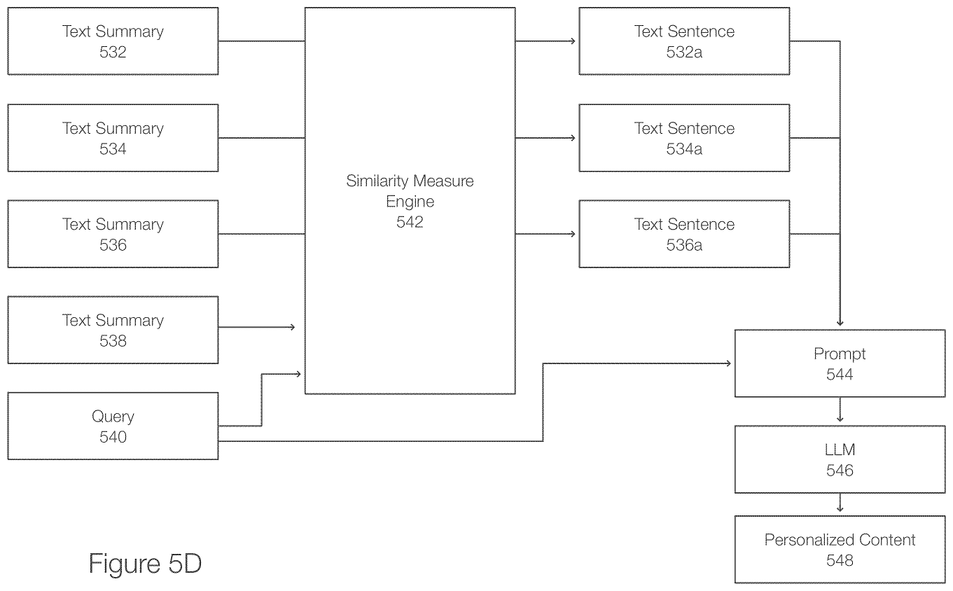

FIGS. 5A-5D disclose an example of generating personalized context to include in a prompt to a large language model. FIG. 5A illustrates a document image 500. During layout detection, various objects were detected in the document image 500. The detected objects include elements 502, 504, 506, and 508 (labeled or classified as text), an element 510 (labeled or classified as a table), and an element 512 (labeled or classified as an image). In this example, the probability for each of the detected objects is higher than a threshold probability and resulted in the labels or classifications illustrated in FIG. 5A.

FIG. 5B illustrates that the objects 501 detected in the document image 500 FIG. 5A have been cropped and are still in image form in one example. In cropped form, the objects 501 can be input to models based on their labels or classifications such that textual summaries for each of the objects 501 can be generated.

FIG. 5C illustrates a visual summarization performed on the objects detected in the document image 500. The objects of the image 500 include text objects 502, 504, 506, and 508. These text objects are input to a model 522 configured to extract text from objects labeled as text. The output of the model 522 includes text summaries 532, 534, 536, and 538, respectively. The model 526 generates a text summary 540 from the table object 510 and the model 526 generates a text summary 542 of the image object 512. The summarized texts 530 for the document image 500 include text summaries 532, 534, 536, 538, 540, and 542.

When processing a document or a batch of documents, the summarized texts 530 may represent the text summaries of objects of a particular document image (e.g., a page of a document) or objects of all document images of a document. This ensures that when comparing a query to the summarized texts, specific document images (e.g., pages) or specific documents are identified and returned.

FIG. 5D illustrates aspects of the online pipeline of the MRAG system. In FIG. 5D, text summaries 532, 534, 536, 538 have been retrieved from storage based on the query 540. The similarity measure engine 542 compares the query 540 with sentences or portions of the text summaries 432, 534, 536, and 538. During augmentation selection, the text summary of a particular object may be divided into sentences and evaluated independently of other sentences in the same object. The sentences that satisfied a threshold measurement score include text sentences 532a, 534a, and 536a from, respectively, text summaries 532, 534, and 536. Sentences from the text summary 538 were not sufficiently similar to the query 540 and were discarded.

A prompt 544 is generated using the text sentences 532a, 534a, and 536a and the query 540. The text sentences 532a, 534a, and 536a provide personalized context that is added to the prompt 544. The prompt 544 is input to the LLM 546 and personalized content 548 or a response is generated.

When aggregating or combining the text sentences 532a, 534a, and 536a and the query 540 into the prompt 544, the relevance of the sentences may be employed in formulating the prompt 544. For example, if sentence 534a was the most similar sentence to the query 540 and the query was “what happened on May 6 in company X finances?”, the prompt 544 may be: Could you summarize the information on what happened to company X finances on May 6 with more attention given to text sentence 534a. Thus, augmented selection can provide personalized context to the prompt 544 and result in personalized content 548 that is expected to be more relevant to the user.

Embodiments of the invention provide a robust framework for enhancing document analysis through a series of steps or acts that include layout detection, visual summarization, and augmentation selection. By leveraging models such as deformable-detr-DocLayNet and InternVL-chat-1-5, diverse document elements can be identified and processed. This advantageously generates comprehensive and contextually relevant output. This framework not only improves the accuracy and relevance of the generated responses but also offers a scalable solution adaptable to various document types and user queries.

It is noted that embodiments disclosed herein, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, prompt context generation operations, machine learning model, including LLM, operations, query operations, multiple model operations for context generation, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide data protection functionality for one or more clients. Another example of a cloud computing environment is one in which processing, data storage, data protection, and other services may be performed on behalf of one or more clients. Some example cloud computing environments in which embodiments may be employed include Microsoft Azure, Amazon AWS, Dell EMC Cloud Storage Services, and Google Cloud. More generally however, the scope of this disclosure is not limited to employment of any particular type or implementation of cloud computing environment.

In addition to the cloud environment, the operating environment may also include one or more clients capable of collecting, modifying, and creating, data. As such, a particular client or server or other computing system may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment.

As used herein, the term ‘data’ or ‘object’ is intended to be broad in scope. Example embodiments are applicable to any system capable of storing and handling various types of objects, in analog, digital, or other form. Synthetic documents and/or corresponding labels are examples of data or objects. An object may be a portion of a document image.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.
Embodiment 1. A method for generating a context to include in a prompt, the method comprising: executing a multimodal information extraction pipeline to generate summarized texts from documents and executing a context generation pipeline configured to generate a personalized context for a query by: retrieving first summarized texts from a storage based on a query, wherein the first summarized texts are a set of the summarized texts closest to the query, and performing augmented selection on portions of the first summarized texts to generate a personalized context.
Embodiment 2. The method of embodiment 1, further comprising performing document conversion on the documents to generate document images for each of the documents.
Embodiment 3. The method of embodiment 1 and/or 2, further comprising performing layout detection on the document images to identify objects in each of the document images.
Embodiment 4. The method of embodiment 1, 2, and/or 3, further comprising performing visual summarization on each of the objects identified in the document images.
Embodiment 5. The method of embodiment 1, 2, 3, and/or 4, wherein the layout detection includes labeling each of the objects with a label, wherein performing the visual summarization includes inputting the objects into different models according to their labels, wherein the models are configured to generate text summaries of the object that are included in the summarized texts.
Embodiment 6. The method of embodiment 1, 2, 3, 4, and/or 5, wherein the summarized texts are embedded and stored as vectors in the storage.
Embodiment 7. The method of embodiment 1, 2, 3, 4, 5, and/or 6, further comprising retrieving first summarized texts by comparing embeddings of the query with embeddings of the summarized texts stored in the storage.
Embodiment 8. The method of embodiment 1, 2, 3, 4, 5, 6, and/or 7, wherein the augmented selection includes selecting sentences from the first summarized texts that are most similar to the query.
Embodiment 9. The method of embodiment 1, 2, 3, 4, 5, 6, 7, and/or 8, wherein the personalized context comprises the selected sentences identified by the augmented selection, further comprising generating the prompt to a large language model by aggregating the selected sentences with the query.
Embodiment 10. The method of embodiment 1, 2, 3, 4, 5, 6, 7, 8, and/or 9, further comprising returning a response of the large language model to the prompt.
Embodiment 11. A system, comprising hardware and/or software, operable to perform any of the operations, methods, or processes, or any portion of any of these, disclosed herein.
Embodiment 12. A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

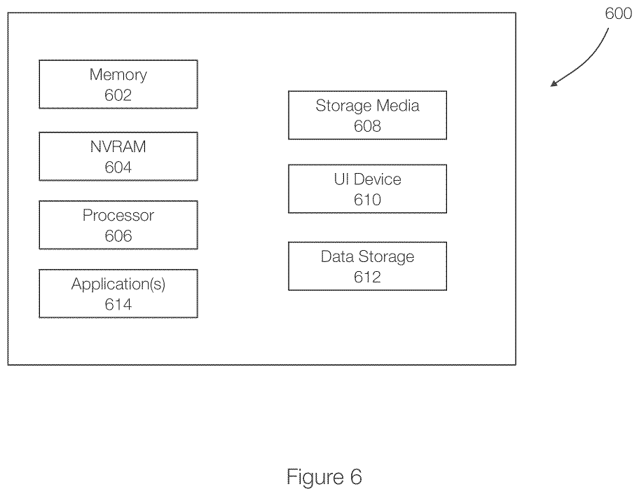

With reference briefly now to FIG. 6, any one or more of the entities disclosed, or implied, by the Figures and/or elsewhere herein, may take the form of, or include, or be implemented on, or hosted by, a physical computing device, one example of which is denoted at 600. As well, where any of the aforementioned elements comprise or consist of a virtual machine (VM), that VM may constitute a virtualization of any combination of the physical components disclosed in FIG. 6.

In the example of FIG. 6, the physical computing device 600 includes a memory 602 which may include one, some, or all, of random access memory (RAM), non-volatile memory (NVM) 604 such as NVRAM for example, read-only memory (ROM), and persistent memory, one or more hardware processors 606, non-transitory storage media 608, UI device 610, and data storage 612. One or more of the memory components 602 of the physical computing device 600 may take the form of solid state device (SSD) storage. As well, one or more applications 614 may be provided that comprise instructions executable by one or more hardware processors 606 to perform any of the operations, or portions thereof, disclosed herein.

The device 600 may also represent a computing system such as a server or set of servers, an edge based computing system, a cloud-based computing system, or the like. The computing system may be localized or distributed in nature.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 600 may also represent a physical or virtual machine or server, an edge-based computing system, a cloud-based computing system, server clusters or other computing systems or environments. The device 600 may also represent multiple machines or devices, whether virtual, containerized, or physical. The device 600 may perform or execute steps or acts of the methods illustrated in the Figures.

The device 600 may represent a cloud-based system, an edge-based, system, an on-premise system, or combinations thereof. Document understanding, context generation, prompt engineering, and related operations may be performed using these types of computing environments/systems.

The described embodiments are to be considered in all respects only as illustrative and not restrictive. All changes which come within the meaning and range of equivalency of the claims are to be embraced within their scope.

What is claimed is:

1. A method for generating a context to include in a prompt, the method comprising:
executing a multimodal information extraction pipeline to generate summarized texts from documents; and
executing a context generation pipeline configured to generate a personalized context for a query by:
retrieving first summarized texts from a storage based on a query, wherein the first summarized texts are a set of the summarized texts closest to the query; and
performing augmented selection on portions of the first summarized texts to generate a personalized context.

2. The method of claim 1, further comprising performing document conversion on the documents to generate document images for each of the documents.

3. The method of claim 2, further comprising performing layout detection on the document images to identify objects in each of the document images.

4. The method of claim 3, further comprising performing visual summarization on each of the objects identified in the document images.

5. The method of claim 4, wherein the layout detection includes labeling each of the objects with a label, wherein performing the visual summarization includes inputting the objects into different models according to their labels, wherein the models are configured to generate text summaries of the object that are included in the summarized texts.

6. The method of claim 5, wherein the summarized texts are embedded and stored as vectors in the storage.

7. The method of claim 1, further comprising retrieving first summarized texts by comparing embeddings of the query with embeddings of the summarized texts stored in the storage.

8. The method of claim 1, wherein the augmented selection includes selecting sentences from the first summarized texts that are most similar to the query.

9. The method of claim 8, wherein the personalized context comprises the selected sentences identified by the augmented selection, further comprising generating the prompt to a large language model by aggregating the selected sentences with the query.

10. The method of claim 9, further comprising returning a response of the large language model to the prompt.

11. A non-transitory storage medium having stored therein instructions that are executable by one or more hardware processors to perform operations for generating a context to include in a prompt, the operations comprising:
executing a multimodal information extraction pipeline to generate summarized texts from documents; and
executing a context generation pipeline configured to generate a personalized context for a query by:
retrieving first summarized texts from a storage based on a query, wherein the first summarized texts are a set of the summarized texts closest to the query; and
performing augmented selection on portions of the first summarized texts to generate a personalized context.

12. The non-transitory storage medium of claim 11, further comprising performing document conversion on the documents to generate document images for each of the documents.

13. The non-transitory storage medium of claim 12, further comprising performing layout detection on the document images to identify objects in each of the document images.

14. The non-transitory storage medium of claim 13, further comprising performing visual summarization on each of the objects identified in the document images.

15. The non-transitory storage medium of claim 14, wherein the layout detection includes labeling each of the objects with a label, wherein performing the visual summarization includes inputting the objects into different models according to their labels, wherein the models are configured to generate text summaries of the object that are included in the summarized texts.

16. The non-transitory storage medium of claim 15, wherein the summarized texts are embedded and stored as vectors in the storage.

17. The non-transitory storage medium of claim 11, further comprising retrieving first summarized texts by comparing embeddings of the query with embeddings of the summarized texts stored in the storage.

18. The non-transitory storage medium of claim 11, wherein the augmented selection includes selecting sentences from the first summarized texts that are most similar to the query.

19. The non-transitory storage medium of claim 18, wherein the personalized context comprises the selected sentences identified by the augmented selection, further comprising generating the prompt to a large language model by aggregating the selected sentences with the query.

20. The non-transitory storage medium of claim 19, further comprising returning a response of the large language model to the prompt.
